(19) United States
(12) Patent Application Publication
(10) Pub. No.: US 2005/0036739 A1
(43) Pub. Date: Feb. 17, 2005

(54) Method and apparatus for mode conversion in a tunable laser

(76) Inventors: Christopher Richard Doerr, Middletown, NJ (US); Lawrence Warren Stulz, Neptune, NJ (US)

Correspondence Address: Theodore Naccarella, Esquire;Synnestvedt & Lechner LLP, 2600 Aramark Tower, 1100 Market Street, Philadelphia, PA, 19107, US

(21) Appl. No.: 10/641,519

(22) Filed: Aug. 15, 2003

(51) Int. Cl. G02B 6/26

(52) U.S. Cl. 385/46; 385/28; 385/37

(57) ABSTRACT

Spot-size conversion for interfacing a first optical element having a higher refractive index to a second optical element having a lower refractive index is achieved through the use of two optical star couplers coupled to each other through a plurality of optical paths embedded in a planar waveguide. The beam from the high refractive index element is introduced into a high numerical aperture (NA) star coupler, which directs the beam through a plurality of optical paths to a second star coupler with a lower numerical aperture than the first star coupler so that its output spot-size is larger. The output port of the second star coupler is interfaced to the lower refractive index element. Wavelength tunability can be provided by including phase shifters in the paths between the two star couplers to alter the effective optical lengths of the paths to selectively produce the desired phase interference pattern.

### FIELD OF THE INVENTION

The invention pertains to semiconductor lasers. More particularly, the invention pertains to mode conversion and frequency tuning of semiconductor lasers.

### BACKGROUND OF THE INVENTION

Wavelength tunable lasers that can be tuned over a wide wavelength range (approximately 30 nanometers) have many uses in telecommunications and other industries, including use in wavelength division multiplexed networks. Also, in optical networks and other environments, it often is necessary to interface semiconductor optical amplifiers and other semiconductor optical devices to optical fibers, planar optical waveguides, and other optical media. These various optical devices and media often have different propagation modes and thus require mode (or spot-size) conversion in order to interface to each other. For instance, optical seminconductor devices such as a semiconductor optical amplifier (i.e., a semiconductor laser) typically have a very small spot size (or mode) compared to an optical fiber or a planar optical waveguide.

The difference in spot-size often is a result of a difference in the refractive index of the light propagating media of the device. For instance, an optical fiber or planar optical waveguide typically has a refractive index of about 1.45 and thus, a relatively small mode (or spot size), whereas a semiconductor laser typically has an optical index of about 3.3 and thus a relatively large mode (or spot size).

Several techniques for mode conversion, therefore, are well known and in common use, such as, the use of lenses or mode converters. The use of lenses to mode convert has several drawbacks, including the expense of the optical components and their assembly, the need to hermetically package the interface, and insertion loss at the free space couplings. Another technique for mode conversion is to fabricate a semiconductor optical amplifier with a horizontal and vertical taper close to its output facet. However, fabricating a vertical taper in a semiconductor is a complex, time consuming and expensive process.

With respect to frequency tuning, the most common type of frequency tunable laser is a distributed Bragg reflector (DBR) laser employing grating-assisted couplers and/or sampled gratings. While these lasers have adequate performance, they require complex InP growth and processing, time consuming testing and calibration, sensitive control, and an external wavelength monitor. They also typically have a small optical mode, requiring precise alignment in order to couple to optical fibers (tolerance of less than 0.1 microns). While such lasers are relatively inexpensive, the above-noted challenges make the price still too high for applications such as fiber-to-the-home.

Another common type of tunable laser is the bulk-optic external cavity laser. These lasers also have adequate performance, but require significant hand assembly and have moving parts.

Another, less common type of tunable laser is an array of fixed-wavelength lasers coupled together with a power combiner. The disadvantages of this approach include complicated processing, limited wavelength tuning, and low output power.

An even less common type of tunable laser is the multifrequency laser (MFL) consisting of semiconductor optical amplifiers (SOAs) monolithically integrated with a waveguide grating router (WGR). Some of the disadvantages of this type of tunable laser are that it requires complex growth and processing and only a small number of them fit on a wafer.

Accordingly, an object of the present invention is to provide an improved tunable laser.

Another object of the present invention is to provide a method and apparatus for mode conversion in an optical system.

Spot-size conversion in one dimension can be provided by providing a horizontal taper near the output facet of the semiconductor optical device and orienting it at a 90° angle to the planar waveguide layer. Due to the 90° orientation of the semiconductor optical device to the planar waveguide layer, the horizontal taper of the semiconductor optical device results in a vertical spot-size increase in the planar waveguide layer.

### SUMMARY OF THE INVENTION

Spot-size conversion for interfacing a first optical element having a higher refractive index, such as a semiconductor optical device, to a second optical element having a lower refractive index, such as an optical fiber, is achieved through the use of two optical star couplers coupled to each other through a plurality of optical waveguides. The star couplers and paths may be embodied in a planar waveguide. To convert spot size in the other dimension, the beam from the high refractive index element is introduced into a high numerical aperture (NA) star coupler such that when the horizontally small spot-size beam hits the relatively lower refractive index planar waveguide and starts to diverge rapidly, the multiple ports of the high NA star coupler collect the rapidly diverging light and guide it into the plurality of waveguides. Each of the plurality of waveguides is coupled at its opposite end to a port of the second star coupler. The second star coupler has a lower numerical aperture than the first star coupler so that its output spot-size is larger. The output port of the second star coupler is interfaced to the lower refractive index element.

To provide wavelength tunability, if desired, each waveguide between the two star couplers is provided with a phase shifter to alter the effective optical length of the waveguide. Tunability of the output wavelength is provided by setting up the proper phase interference pattern between the light in each waveguide. The combination of these two changes in spot-size results in an overall mode of conversion in both the vertical and horizontal directions.

### BRIEF DESCRIPTION OF THE DRAWINGS

FIG. 1 is a pictorial representation of a tunable laser employing mode conversion in accordance with an embodiment of the present invention.

FIG. 2 is a pictorial plan view illustrating relative layout of the star couplers and the waveguides in accordance with an embodiment of the present invention.

FIG. 3 is a pictorial representation of a tunable laser in accordance with another embodiment of the present invention.

FIG. 4 is a graph illustrating optical power as a function of wavelength for seventeen different values of q, i.e., for seventeen different grating orders, by applying parabolic phase shift distributions to the grating arms of various strengths in a tunable laser in accordance with the present invention

FIG. 5 is a graph illustrating optical power as a function of wavelength for three different values of p for q=1, i.e., for different wavelengths within a grating order, by applying linear phase shift distributions of three different strengths across the grating arms.

### DETAILED DESCRIPTION OF THE INVENTION

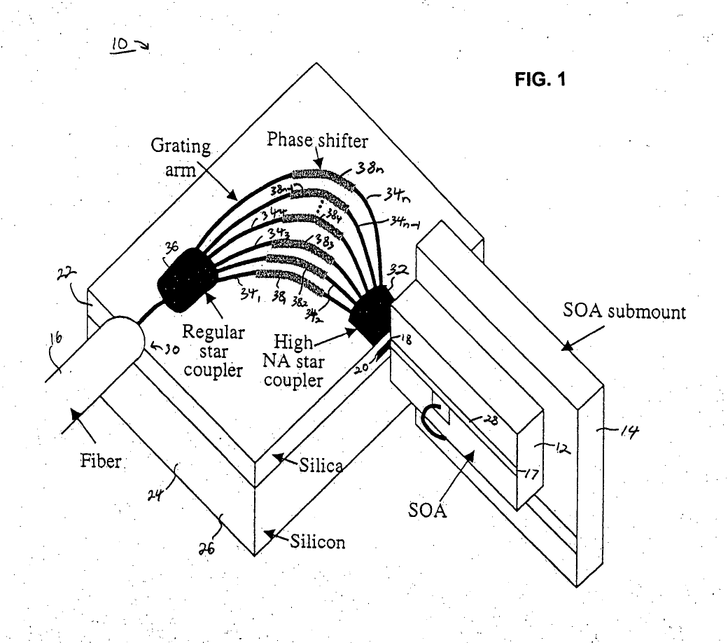

FIG. 1 illustrates the basic components of a wavelength tunable laser with mode conversion in accordance with a particular embodiment of the present invention. An optical element with a relatively high refractive index, such as a semiconductor optical device, and, more particularly, a semiconductor optical amplifier (SOA) 12 is mounted on a submount 14. The SOA may comprise any form, but in one preferred embodiment is an InP laser. In the illustrated embodiment, the light output from the SOA 12 is to be coupled to another optical element having a lower refractive index, such as an optical fiber 16. Accordingly, the mode or spot size of the beam in the SOA 12 is smaller than the mode or spot size in the fiber 16. The output media does not necessarily have to comprise an optical fiber, but can take many other forms, including waveguides, planar waveguides, another semiconductor, etc. The SOA 12 has an output facet 18 coupled to a facet 20 in a silica waveguide layer 22 of a waveguide structure 24. The silica waveguide layer 22 is disposed on a silica base layer 26. The materials are merely exemplary. In the particular embodiment of FIG. 1, the lasing channel comprises the waveguide 28 of the SOA 12 and the waveguide circuit 24 (as described hereinbelow). Accordingly, facets 18 and 20 are nonreflective (and preferably are coated with an anitireflection coating), but facet 30 in the silica waveguide layer 22 that interfaces with the fiber 16 is partially reflective so as to define the lasing cavity as the cavity between the back end of the SOA 12 and the facet 30 of the silica waveguide layer 22.

The optical pathway in the waveguide structure 24 comprises a first star coupler 32 adjacent facet 20, a plurality of waveguides 34₁-34ₙ (also referred to herein as grating arms), and a second star coupler 36. Preferably, the optical length of each grating arm 34₁-34ₙ is different. In a preferred embodiment, the physical lengths of the grating arms differ from each other by integer multiples of the wavelength of the light output from SOA 12. Furthermore, the effective optical length of each grating arm 34₁-34ₙ is individually adjustable by means of a phase shifter 38₁-38ₙ associated with each grating arm. In a preferred embodiment of the invention, the phase shifters 38₁-38ₙ are thermo-optic phase shifters. Thermo-optic phase shifters are known in the related arts and comprise a heating element positioned adjacent each grating arm, with each heating element being individually energizable to heat the corresponding grating arm. The temperature variation changes the effective optical length of the path through the grating arm. The thermo-optic phase shifters, therefore, can be used to adjust the effective path lengths in the various grating arms to, in turn, adjust the phase interference between the light in the various grating arms in order to tune the wavelength of the light output to fiber 16.

Two aspects of the design of the present invention provide mode conversion. First, the plane of the SOA is oriented at a 90° angle to the plane of the silica waveguide layer 22. The SOA may be attached to the waveguide in any reasonable fashion, such as by adhesive. The 90° orientation of the SOA 12 to the silica waveguide 22 causes the horizontal aspect of the spot-size at the output facet 18 of the SOA to become the vertical spot-size aspect in the silica waveguide layer 22 and the vertical aspect of the beam spot-size at the output facet 18 of the SOA 12 to be the horizontal aspect of the spot-size in the waveguide layer 22. As such, in accordance with this feature of the invention, the horizontal aspect of the spot-size output from the output facet 18 of the SOA 12 can be made to match the desired vertical aspect of the spot-size for the silica wavelength layer 22 and/or the fiber 16 simply by horizontally tapering the SOA optical channel 28 to the desired horizontal dimension adjacent the output facet 18. More specifically, the channel 28 in the SOA 12 can be horizontally widened so as to provide a vertical aspect of the spot-size equal to the desired vertical aspect for the spot-size in the silica waveguide 22 or fiber 16. Waveguide layers, such as waveguide layer 22, and fiber 16 typically will both be made of the same material and thus have the same mode/spot-size. Hence, the vertical aspect of the spot size in the waveguide layer 22 should be the same spot size desired for the fiber 16.

Providing a horizontal taper to the optical path 28 in the SOA in order to convert one dimension (i.e., aspect) of the spot between the SOA and the fiber/waveguide layer can be achieved easily during fabrication. Essentially, it requires that a single fabrication mask used to create the optical channel be patterned accordingly (whereas vertical tapering of the optical path 28 in the SOA in order to mode match the spot-size in the second dimension would be impractically complex and expensive for most commercial products). Accordingly, by horizontal tapering in the SOA, one aspect of the mode conversion is easily achieved. However, in the horizontal aspect, the output of the SOA still will be very small (typically on the order of six to nine times smaller) than that desired in silica waveguide layer 22 or optical fiber 16.

In accordance with the present invention, the horizontal aspect of the spot-size is converted within the waveguide layer 22 by the appropriate selection and use of the star couplers 32 and 36. Particularly, as is well known in the arts, when a light beam is introduced into a waveguide, such as silica waveguide layer 22, in a mode much smaller than the fundamental mode of the waveguide, significant optical power will be lost. In accordance with the present invention, in order to prevent the rapid dissipation of the beam in the waveguide layer 22, only a small free space region with a high numerical aperture is provided in the silica waveguide layer 22 between the facet 18 and the input ports of the first star coupler 32. (Note that the terms “input” and “output” are merely exemplary in this specification since, as will become clear, light may travel in either direction through the star couplers 32 and 36 and the various facets 18, 20, and 30. In fact, in the preferred embodiment described herein, light travels through star couplers 32 and 36 and facets 18 and 20 in both directions since they are all within the lasing cavity. For purposes of simplifying the discussion herein, parts at the right side of an optical element in FIG. 1 will herein be termed “input” ports and ports at the left side of an optical element will be termed “output” ports for ease of reference.) Thus, the beam is almost immediately collected into a plurality of waveguides arranged in a radial pattern that collects most of the widely dispersing light. This type of radial arrangement of waveguides is known in the related arts as a star coupler and is commonly used to couple one waveguide to many waveguides.

Since the spot size output from the SOA 12 is so small, the star coupler 32 should be a high numerical aperture star coupler 32 and be placed immediately adjacent the facet 20. The “output” ports of star coupler 32 are coupled to the aforementioned grating arms 34₁-34ₙ. The opposite ends of the grating arms 34₁-34ₙ are coupled to the input ports of a second star coupler 36 having a lower numerical aperture than the first star coupler 32. The numerical aperture of the second star coupler 36 is specifically chosen to provide a horizontal aspect of the spot-size at the output port of the second star coupler 36 matched to the mode of the fiber 16 (which, as previously noted, is likely to be the same mode as for the waveguide layer 22 itself).

The output port of the second star coupler 36 is coupled into the fiber 16 through a further waveguide 37 and a partially reflective facet 30. The light at facet 30 is mode matched to the fiber 16 in both its vertical and horizontal aspects. However, waveguide 37 is optional, and the fiber may be directly coupled to star coupler 36.

Facet 30 is partially reflective, because, in a preferred embodiment of the invention as described hereinbelow, the lasing cavity comprises the entire optical path between the back facet 17 of the SOA 12 and the output facet 30 of the silica waveguide. (Particularly, as noted above, the wavelength tuning is provided in the waveguide layer 22.) In other embodiments in which lasing is not desired in the waveguide layer 22 (e.g., a non-tunable laser), then facet 30 may be a non-reflective facet and facet 18 of the SOA should be partially reflective. Even further, in a non-tunable embodiment of the invention, phase shifter 38₁-38ₙ are not necessary and may be omitted.

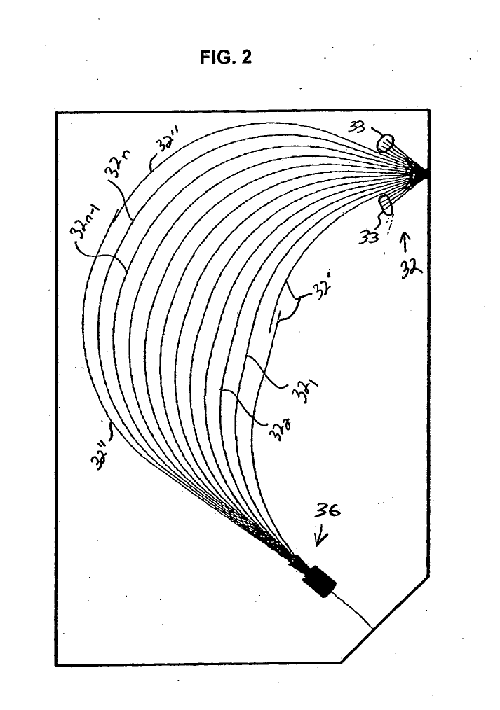

FIG. 2 shows a layout for the grating arms 32₁-32ₙ in accordance with one preferred embodiment of the invention. Note that the angular spread of the grating arms is greater at the high numerical aperture star coupler 32 than at the lower NA coupler 36.

Also, an extra “dummy” waveguide 33₁ and 33₂ is provided to the outside of each of the first and last waveguides 34₁-34ₙ. The use of the dummy paths 331, 332 to the outside of the first and last grating arms makes the etching more uniform for the actual grating arms. Specifically, fabricating the shortest and longest light paths as dummies helps make the etching of the intermediate paths, i.e., the actual grating arms 34₁-34ₙ, more uniform. In addition, several more very short dummy paths or dummy ports 35 are provided in each of the star couplers 32 and 36. These dummy paths 35 serve the same purpose as the dummy paths 33₁, 33₂. Particularly, they allow for the etching of the actual grating arms to be more uniform. They also make the coupling into and out of the star couplers more uniform.

While a particular embodiment of the invention has been hereinabove described in connection with a system in which light is amplified in SOA 12 and waveguide 24 and output to a fiber 16, it should be understood that the general direction of the light is irrelevant and that the invention described hereinabove also will work if the general direction of the light is in the opposite direction, i.e., light is input to the system from fiber 16 for amplification by the device 10 and output from the facet 17 of SOA 12. Of course, in such an embodiment, facet 17 would be a partially reflective facet and would be coupled to a further optical component. For instance, another waveguide structure similar or identical to waveguide structure 24 might be coupled to the facet 17 of the SOA 12 in order to mode convert before coupling into another fiber similar or identical to fiber 16.

The physical lengths of the waveguides (i.e., ignoring the effect of the phase shifters for the moment) may be selected so as not to be perfectly linearly spaced, but to have a small amount of nonlinearity so as to help assure that the path lengths cannot add up constructively to more than one wavelength in more than one free spectral range. By properly controlling the phase shifters 38₁-38ₙ, two types of tuning can be achieved. Particularly, by using the phase shifters to provide a linear distribution in path lengths among the grating arms, the tuned wavelength can be changed within a single free spectral range. However, if it is desired to achieve wider wavelength tunability over a plurality of free spectral ranges, the phase shifters can be configured to apply a parabolic distribution in path lengths among the grating arms.

In an alternative embodiment, the method and apparatus of the present invention may be used solely to mode convert without providing wavelength tunability. In such an embodiment, the phase shifters 38₁-38ₙ would be unnecessary and could be omitted. Also, the physical path lengths through the various grating arms could all be the same. Furthermore, in a non-tunable embodiment, it would be desirable, although not necessary, to make facet 30 non-reflective. In such a case, SOA 12 may instead be a laser, such as distributed-feedback laser.

Alternately, one can employ the wavelength tuning features of the invention without employing the mode conversion features of the invention. Furthermore, in such a case, the SOA, star couplers and grating arms may be constructed entirely in semiconductor, if desired. In such a case, mode conversion would not be an issue since all of the components would be fabricated of the same material and, thus, have the same refractive index.

In such embodiments, the two star couplers should have the same or similar numerical apertures, whether fabricated in semiconductor or silica. For instance, if, instead of being coupled to fiber 16, the left side of waveguide device 24 were coupled to another semiconductor optical device, then the two star couplers 32 and 36 should both be high numerical aperture star couplers, preferably having the exact same numerical apertures.

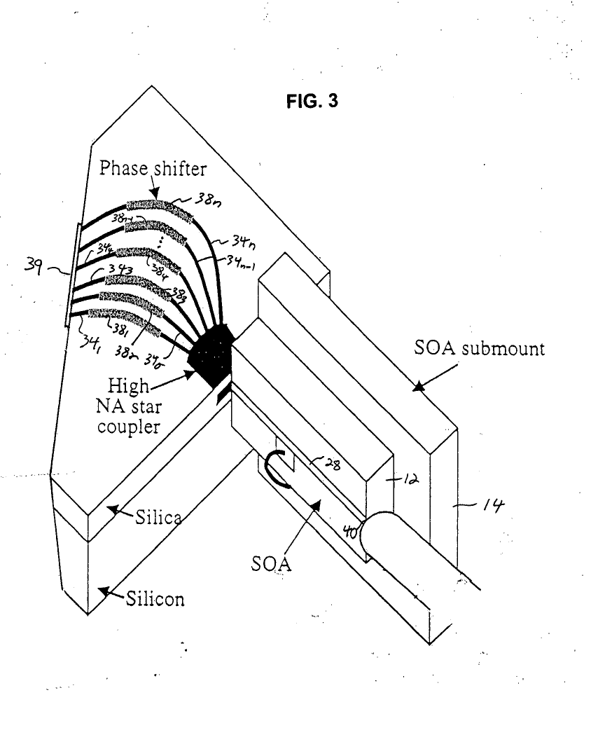

As an even further alternative in the form of a wavelength tuner and/or an amplifier without mode conversion, the second star coupler 36 could be entirely eliminated and the waveguides instead terminated at highly reflective facets. FIG. 3 shows such an embodiment. In this embodiment, SOA 12 may remain essentially the same. In the waveguide structure 24, star coupler 32, waveguides 34, phase shifters 38, and facet 20 also may remain essentially the same. However, the waveguides 34, instead of being terminated at a second star coupler, are all terminated at a highly reflective facet 39. The light is amplified and tuned essentially as described above in connection with the embodiment of FIGS. 1 and 2. However, instead of mode converted light exiting out of the far end of the waveguide structure, all of the light is reflected back to the SOA. In this embodiment, the facet at the back side of SOA 12 is replaced with a partially reflective facet 40 and an output fiber 41 is coupled to the back facet 40 of the SOA.

We have constructed an actual prototype for observation and testing purposes. A description of that prototype follows.

To simultaneously meet the requirement of (a) a small number of phase shifters (for low power consumption and easier packaging), (b) a narrow passband (for single-mode operation), and (c) a large tuning range, the WGR has a very small free-spectral range and is chirped. The chirp defocuses all grating orders but one. The grating-arm length distribution is:

$$L ( m ) = round \{ [ m + {γ ( m - \frac{M + 1}{2} )}^{2} ] A \} {λ}_{c}$$

where M is the number of waveguide grating arms, A is the starting grating order, λ is the chirp parameter, and λ_{c} is the zero-phase-shifter-power wavelength.

Actually, when the grating order is very high (˜1000), as in the present case, the chirp peak itself has an approximate free spectral range of 1/(2γ) times the WGR equivalent unchirped free-spectral range. This chirp free-spectral range must be larger than the SOA gain bandwidth in order to assure single-mode laser oscillation, thus placing an upper bound on γ.

The WGR can tune the wavelength from grating order to grating order by applying a parabolic phase shift distribution via the phase shifters, and can tune the wavelength within each grating order by applying a linear plus parabolic distribution. The phase shifter setting φ in arm m to focus grating order q (any integer) and channel p (any number between −1 and 1) around that grating order on the output waveguide is

$$ϕ ( m ) = \frac{2 {πλ }_{c}}{{λ}_{g}} [ pm + ( p + q ) {γ ( m - \frac{M + 1}{2} )}^{2} ] mod 2 π$$

The modulo is used to mitigate the power consumption by making sure all the applied phase shifts are less than 2π. Finally, an additional advantage of using silica for the passive part of the laser cavity is avoidance of the power limitations in passive InP caused by two-photon absorption. Thus, this laser has the potential for very high output power.

For the SOA, for convenience, we used the same structure as commonly used for making a monolithically integrated MFL. It consists of four compressively strained buried quantum wells sitting on a 0.46 μm-thick graded bandgap quaternary slab. The two SOA facets are cleaved. One is coated with TiO2 as the anti-reflection (AR) coating and the other is uncoated. The optical channel is ˜900 μm long.

For the silica PLC, we used 0.65% index step phosphorous-doped LP-CVD buried silica 6 μm-thick cores. One may use higher index step waveguides in order to shorten the cavity length and better mode match the horizontal mode of the SOA. The WGR has ten grating arms, λ_{c}=1.555 μm, the unchirped free-spectral range is 200 GHz (A 948 at Ic), and the chirp parameter is 0.0296 (thus the chirp “free-spectral range” is ˜27 nm). The output waveguide has a phase shifter for adjusting the cavity length and bends 8° before reaching the facet. We polished the output facet and deposited a single quarter-wave layer of Si. Since the output is glued directly to a fiber, this results in 43% reflectivity. For the facet glued to the SOA, we cut it at an 8°-angle, top-to-bottom, and did not polish it. The capture angle of the high-NA star couplers was about 41°. There is a 3-mm long heater on the center of each grating arm, serving as the phase shifter. Because the grating has such a high order, the distance between grating arms in the center is approximately 520 mm, and thus there is negligible inter-phase-shifter thermal crosstalk.

To assemble the laser, first the fiber was glued to the silica chip output waveguide. Then the silica chip was glued to a copper block, which was glued to a thermoelectric (TE) cooler, and all eleven phase shifters, ten on the grating arms and one on the output waveguide) were attached via wire bonds to an electrical connector. The SOA was soldered to a submount, which was soldered to a small copper block. The SOA was wire-bonded to the submount, and wires were attached to the submount. The SOA assembly was rotated 90°, swung upwards 8°, and glued to the silica chip using active alignment.

The SOA has gain for only transverse-electrically (TE)-polarized light. Thus the laser light in the silica chip is transverse-magnetically (TM) polarized. This is advantageous because SOAs usually are more efficient for TE-polarized light, while silica thermo-optic phase shifters usually are more efficient for TM-polarized light.

The laser oscillation threshold at 20° C. is approximately 50 mA. The thermo-optic phase shifter efficiency is 2p/(750 mW). Thus the total phase shifter power consumption can be as much as 4 W. The TE cooler could not hold the 20° C. temperature used in the following measurements at such a power dissipation level, and so we had to cool the TE-cooler heat sink to take the measurements reported below. Etching trenches around the phase shifters potentially would reduce the total chip power consumption to less than 0.5 W.

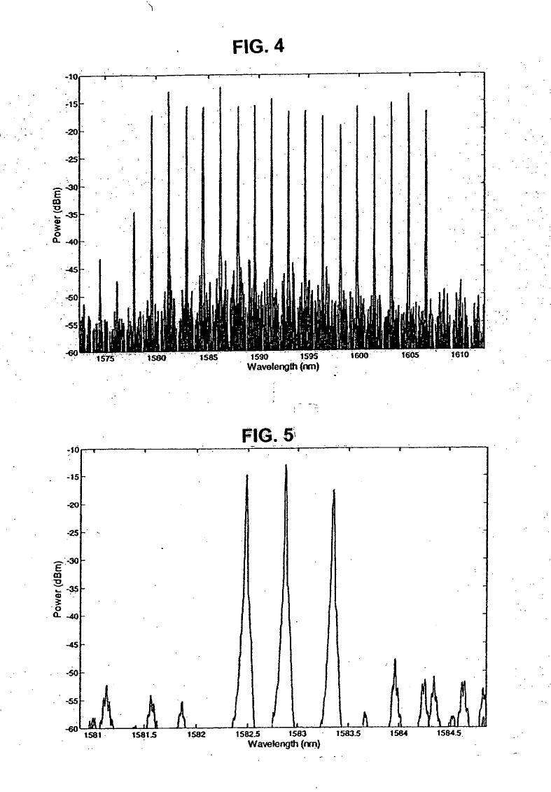

FIG. 4 shows measured spectra of the laser output for various values of q applied to the phase shifters. The laser tuning range is approximately 25 nm. The SOA gain peak is approximately 35 nm higher than Ic, so the laser wavelengths are concentrated around the next higher chirp order, which is slightly more lossy. The SOA AR coating is imperfect (reflectivity ˜2%), and thus one can see ripple with a period of 0.28 nm and peak-to-peak amplitude of about 5 dB (when the laser is oscillating) in the spontaneous emission spectrum. This causes laser instability and multimode oscillation, depending on the position of the reflection-induced ripple. The cavity mode spacing is approximately 3 GHz. The SOA current was approximately 100 mA for all measurements. The output power in the fiber was typically 50 mW. The side mode suppression ratio, when the SOA facet is not causing multimode oscillation, is greater than 30 dB. FIG. 5 shows the result of holding q constant but changing p, showing that the laser wavelength can be tuned within about one grating order.

We did not measure the tuning speed, but based on the known speed of silica thermo-optic phase shifters, we expect it to be about 2 ms. Also, we did not measure the direct modulation speed, but it may be possible to achieve 2.5 Gb/s with this laser using electronic precompensation.

We have demonstrated a laser with a tuning range of about 25 nm based on direct attachment of a low-cost SOA and a lost-cost silica chip with no precise alignments. Alterations to the above-described design that will likely improve performance include: 1) eliminating the SOA/glue reflection by angling the SOA waveguide; 2) using an SOA purely optimized for high saturation output power and good high temperature performance; 3) using trenched thermo-optic phase shifters to reduce their power consumption; and 4) using higher delta silica waveguides to increase the cavity mode spacing and facilitate the vertical mode matching to the SOA lateral mode.

This present invention could be integrated with other functions in the silica waveguide chip.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A mode converter comprising:
a first star coupler having a first numerical aperture;
a second star coupler having a second numerical aperture different than said first numerical aperture; and
a plurality of waveguides coupled between said first star coupler and said second star coupler.

2. The mode converter of claim 1 wherein said mode converter is formed in a planar waveguide layer.

3. The mode converter of claim 2 further comprising at least one dummy waveguide between said first and second star couplers

4. The mode converter of claim 3 wherein at least one dummy waveguide comprises first and second dummy waveguides bracketing said plurality of waveguides.

5. The mode converter of claim 2 wherein at least one of said first and second star couplers comprises a plurality of actual ports, each coupled to one of said plurality of waveguides and a plurality of dummy ports.

6. The mode converter of claim 5 wherein a first subset of said dummy ports is positioned on a first side of said actual ports and a second subset of said dummy ports are positioned on a second side of said actual ports.

7. The mode converter of claim 2 further comprising a heat sink upon which said planar waveguide layer is mounted.

8. The mode converter of claim 1 wherein said plurality of waveguides are each of a different length.

9. The mode converter of claim 8 wherein said waveguides differ in length from each other by integer multiples of a wavelength of light.

10. The mode converter of claim 1 further comprising a phase shifter associated with each waveguide.

11. The mode converter of claim 10 wherein said phase shifters comprise thermo-optic phase shifters.

12. A light amplification system comprising:
The mode converter of claim 1; and
a semiconductor optical amplifier having an output port coupled to said first star coupler.

13. The light amplification system of claim 12 wherein said mode converter is formed in a planar waveguide layer and said semiconductor optical amplifier and said planar waveguide are oriented orthogonal to each other.

14. The light amplification system of claim 13 wherein said semiconductor optical amplifier comprises a lasing cavity that is tapered to widen adjacent said output such that said cavity at said output port has a horizontal size matched to the vertical size of said waveguide layer of said mode converter.

15. The light amplification system of claim 14 wherein a lasing cavity comprises said mode converter and said semiconductor optical amplifier.

16. The light amplification system of claim 15 wherein said semiconductor optical amplifier comprises a non-reflective facet and said waveguide layer further comprises a first port having a non-reflective facet coupled between said non-reflective facet of said semiconductor optical amplifier and said first star coupler and a second port having a partially reflective facet coupled between said second star coupler and a port of said waveguide layer.

17. The light amplification system of claim 16 wherein said mode converter further comprises a phase shifter associated with each waveguide, whereby said light amplification system is wavelength tunable by altering the effective path length through said waveguides by said phase shifters.

18. The light amplification system of claim 17 wherein said phase shifters comprise thermo-optic phase shifters.

19. The light amplification system of claim 17 wherein said plurality of waveguides are each of a different length.

20. The light amplification system of claim 19 wherein said waveguides differ in length from each other by integer multiples of a wavelength of light.

21. The light amplification system of claim 12 further comprising a further waveguide coupled to direct light between said second star coupler and said second port of said mode converter.

22. A method of coupling light between a first optical element having a first mode and a second optical element having a second mode, said second mode having a larger spot size than said first mode in an optical communication system, said method comprising the steps of:
(1) coupling light between said first optical element and a first star coupler having a first numerical aperture;
(2) coupling said light between said first star coupler and a plurality of waveguides;
(3) coupling said light between said plurality of waveguides and a second star coupler having a second numerical aperture lower than said first numerical aperture; and
(4) coupling light between said second star coupler and said second optical element.

23. The method of claim 22 wherein said first and second star couplers and said plurality of waveguides are formed in a planar waveguide layer defining a horizontal dimension and a vertical direction orthogonal to said horizontal direction and wherein step (1) comprises coupling said light by means of an interface in which said light is mode matched in the horizontal dimension within said planar waveguide layer.

24. The method of claim 23 wherein said second optical element is vertically mode matched to said waveguide layer and wherein step (4) comprises coupling said light via a further waveguide in said planar waveguide layer coupled between said second star coupler and said second optical element.

25. The method of claim 24 further comprising the step of:
(5) altering effective optical path lengths of each of said plurality of waveguides so as to set up phase interference between light in each of said plurality of waveguides so as to wavelength tune said light.

26. The method of claim 25 wherein step (5) comprises providing a phase shifter for individually changing the effective optical path length in each of said waveguides of said plurality of waveguides.

27. The method of claim 26 wherein step 5 comprises providing a thermo-optic phase shifter associated with each waveguide of said plurality of waveguides.

28. The method of claim 25 wherein step (5) comprises setting up said effective optical path lengths to cause said plurality of waveguides to have linearly varying phase shift distribution relative to each other so as to provide wavelength tunability within a single free spectral range.

29. The method of claim 25 wherein step (5) comprises setting up said effective optical path lengths to cause said plurality of waveguides to have parabolically varying phase shift distribution relative to each other so as to provide wavelength tunability over a plurality of free spectral ranges.

30. A method of converting the mode of a light beam, said method comprising the steps of:
(1) coupling said light beam into a first star coupler having a first numerical aperture;
(2) coupling said light beam between said first star coupler and a second star coupler having a second numerical aperture different than said first numerical aperture; and
(3) coupling said light beam out of said second star coupler.

31. The method of claim 30 wherein step (2) comprises coupling said light beam between said first and second star couplers through a plurality of optical paths and further comprising the step of:
(4) altering effective optical lengths of each of said plurality of optical paths so as to set up phase interference between light in each of said plurality of waveguides so as to wavelength tune said light beam.

32. The method of claim 31 wherein step (5) comprises setting up said effective optical path lengths to cause said plurality of optical paths to have linearly varying phase shift distribution relative to each other so as to provide wavelength tunability within a single free spectral range.

33. The method of claim 31 wherein step (4) comprises setting up said effective optical path lengths to cause said plurality of waveguides to have parabolically varying phase shift distribution relative to each other so as to provide wavelength tunability over a plurality of free spectral ranges.

34. An apparatus for converting the mode of a light beam comprising:
(1) means having a first numerical aperture at a terminal thereof for receiving said light beam;
(2) means having a second numerical aperture at a terminal thereof for outputting said light beam; and
(3) means for coupling said light beam between said means for receiving and said means for outputting.

35. The apparatus of claim 34 wherein said means for coupling comprises a plurality of optical paths, said apparatus further comprising:
(4) means for altering effective optical lengths of each of said plurality of optical paths.
